(19) United States
(12) Patent Application Publication
(10) Pub. No.: US 2014/0001086 A1
(43) Pub. Date: Jan. 2, 2014

(54) RETAINING ASSEMBLY FOR FLAT ELECTRONIC DEVICE

(71) Applicants: HON HAI PRECISION INDUSTRY CO., LTD., New Taipei (TW); HONG FU JIN PRECISION INDUSTRY (ShenZhen)CO.,LTD., Shenzhen (CN)

(72) Inventors: CHUN LIU, Shenzhen (CN); CHI-WEN CHIANG, New Taipei (TW)

(21) Appl. No.: 13/913,458

(22) Filed: Jun. 9, 2013

(30) Foreign Application Priority Data
Jun. 28, 2012 (CN) 2012102177971

(51) Int. Cl. G06F 1/16

(52) U.S. Cl. CPC G06F 1/16
USPC 206/736

(57) ABSTRACT

A support assembly for an electronic device includes a first supporting board and a second supporting board. The first supporting board includes at least one first retaining portion. At least one first groove is defined in the first supporting board. The second supporting board includes at least one second retaining portion. The first supporting board and the second supporting board are configured to support the electronic device in a support state and retain the electronic device in a retaining state. In the support state, the first supporting board and the second supporting board intersect with each other and the second supporting board is engaged in a groove. In the retaining state, the first supporting board and the second supporting board cover the electronic device and are retained to the electronic device.

### BACKGROUND

1. Technical Field

The disclosure generally relates to retaining assemblies, especially to a retaining assembly for a flat electronic device, such as a flat screen computer.

2. Description of Related Art

A traditional flat electronic device, such as a flat screen computer, a liquid crystal display, a smart phone, may include a protection cover for protecting the flat electronic device and a stand for supporting the flat electronic device when to enjoy the electronic device on a table. However, the protection cover and the stand are separate and it is inconvenient to take these two accessories with the electronic device as a portable device. There is a room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a flat electronic device and a support assembly in a first embodiment.

FIG. 2 is an isometric view of the flat electronic device and a support state of the support assembly of FIG. 1.

FIG. 3 is an isometric view of the flat electronic device and a retaining state of the support assembly of FIG. 1.

FIG. 4 is a lateral view of the flat electronic device and the retaining state of the support assembly of FIG. 3.

FIG. 5 is an exploded, isometric view of a support assembly in a second embodiment.

FIG. 6 is an isometric view of a flat electronic device and a support state of a support assembly in a third embodiment.

FIG. 7 is a lateral view of the flat electronic device and a retaining state of the support assembly of FIG. 6.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

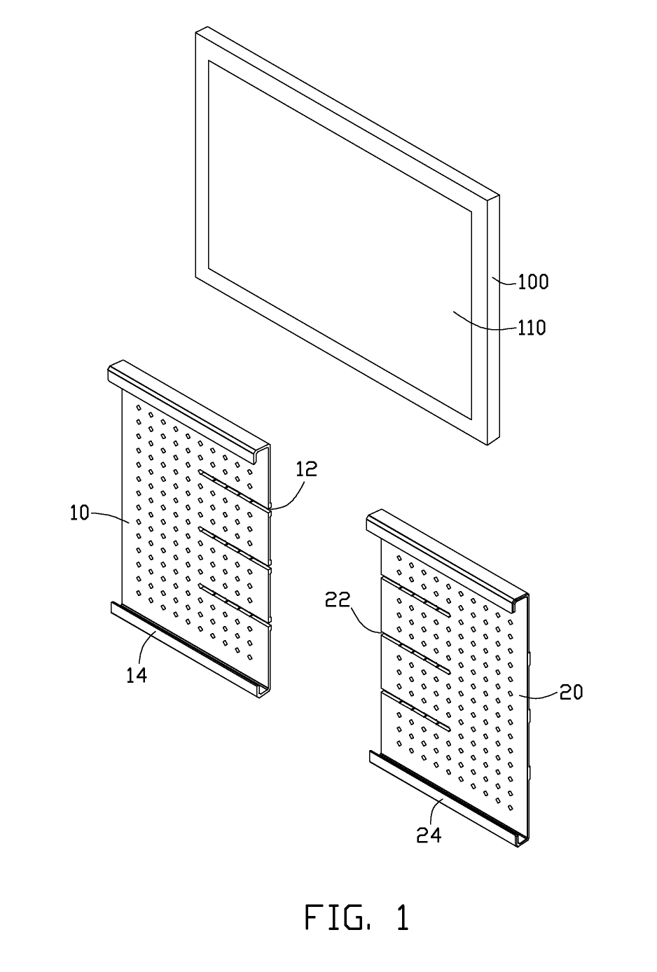

FIG. 1 illustrates one embodiment of a flat electronic device 100 and a support assembly for supporting and covering the flat electronic device 100. The flat electronic device 100 may be a flat screen computer, a display, or a smart phone. The flat electronic device 100 includes a screen 110. The screen 110 may be a touch sensitive display.

The support assembly includes a first supporting board 10 and a second supporting board 20. The first supporting board 10 and the second supporting board 20 may have substantially a symmetrical configuration. The first supporting board 10 and the second supporting board 20 are substantially rectangular.

The first supporting board 10 includes two first retaining portions 14 on opposite sides. Three spaced first grooves 12 are defined in the first supporting board 10. The three first grooves 12 are parallel. The three first grooves 12 extend from a lateral edge of the first supporting board 10 into a middle portion of the first supporting board 10. The two first retaining portions 14 extend towards each other. A cross section of each of the two first retaining portions 14 is substantially L-shaped. A first receiving space is defined by the first supporting board 10.

The second supporting 20 includes two second retaining portions 24 on opposite sides. Three spaced second grooves 22 are defined in the second supporting board 20. The three second grooves 22 are parallel. The second grooves 22 extend from a lateral edge of the second supporting board 20 into a middle portion of the second supporting board 20. The two second retaining portions 24 extends towards each other. A cross section of each of the two second retaining portions 24 is substantially L-shaped. A second receiving space is defined by the second supporting board 20.

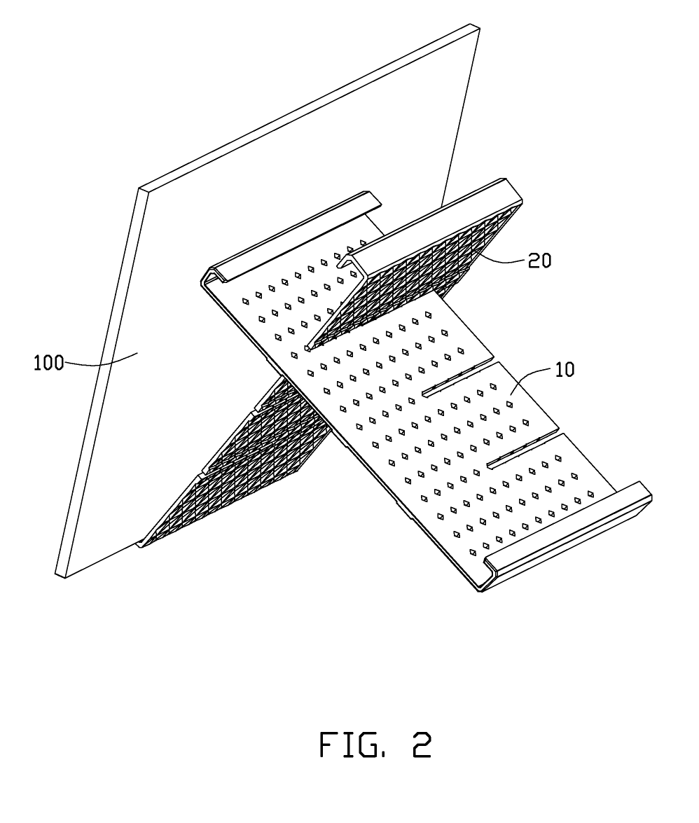

FIG. 2 illustrates a support state of the support assembly in relation to the flat electronic device 100. The first supporting board 10 and the second supporting board 20 are intersecting each other. A top first groove of the three first grooves 12 is engaged with the second supporting board 20 through a top second groove of the three second grooves 22. A bottom edge of the flat electronic device 100 is clasped on a bottom second retaining portion of the two second retaining portions 24. A back side of the flat electronic device 100 abuts on a top first retaining portion of the two first retaining portions 14. The flat electronic device 100 is stood by the first supporting board 10 and the second supporting board 20 at a first angle.

To support the flat electronic device 100 at a second angle, the top first groove of the three first grooves 12 can be engaged with the second supporting board 20 through a middle second groove of the three second grooves 22. The supporting angle of the first supporting board 10 and the second supporting board 20 is changed. Therefore, in similar manner, the one of the three first grooves 12 can be selectively engaged with one of the second grooves 22 to adjust the supporting angle.

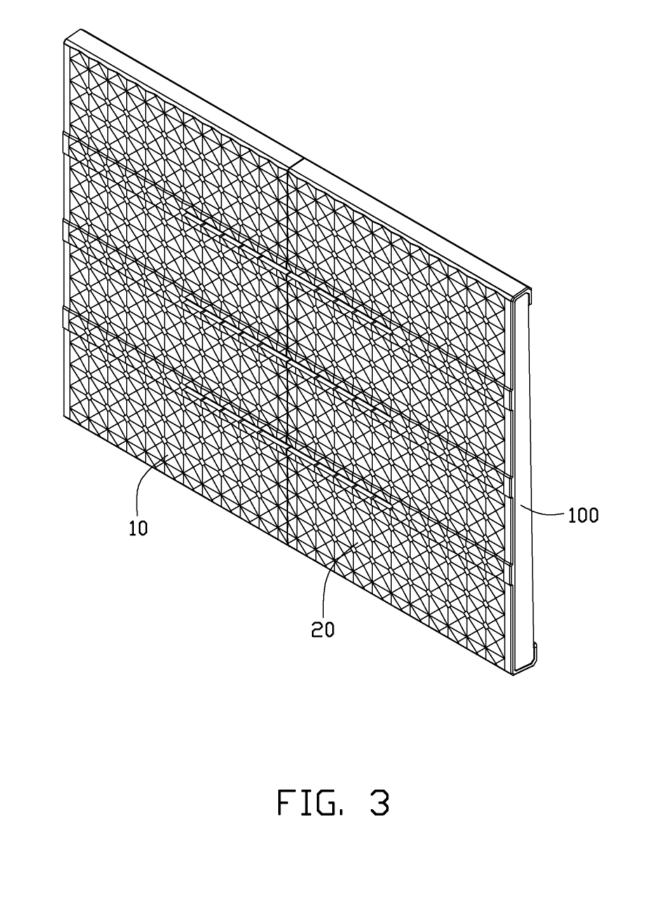

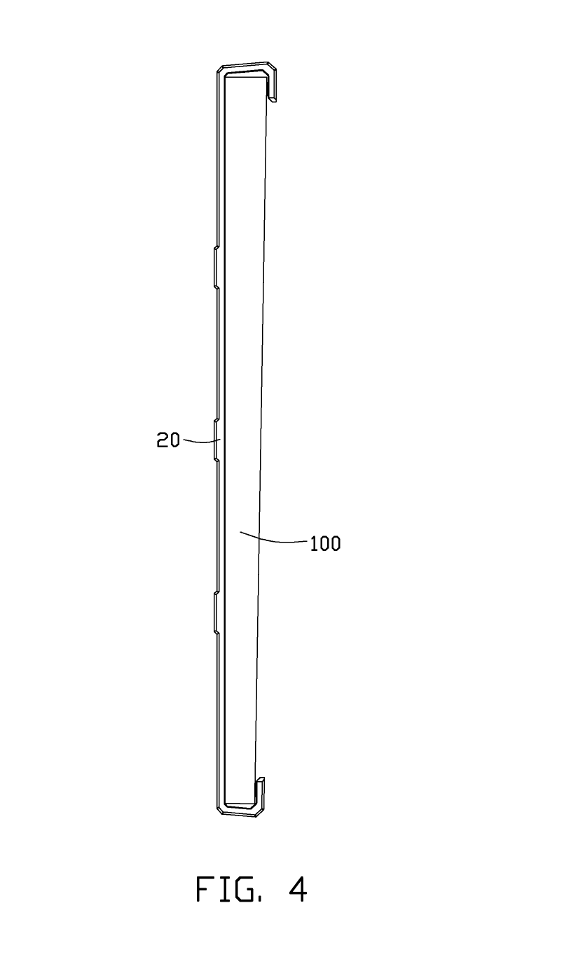

FIG. 3 and FIG. 4 illustrate a retaining state of the support assembly to the flat electronic device 100. The first supporting board 10 and the second supporting board 20 are aligned. The two first retaining portions 14 and the two second retaining portions 24 are retained on two opposite edges of the flat electronic device 100. The first retaining portion 14 and the second retaining portion 24 cooperatively cover the back side of the flat electronic device 100 for protecting the flat electronic device 100. The flat electronic device 100 is received in the first receiving space and the second receiving space.

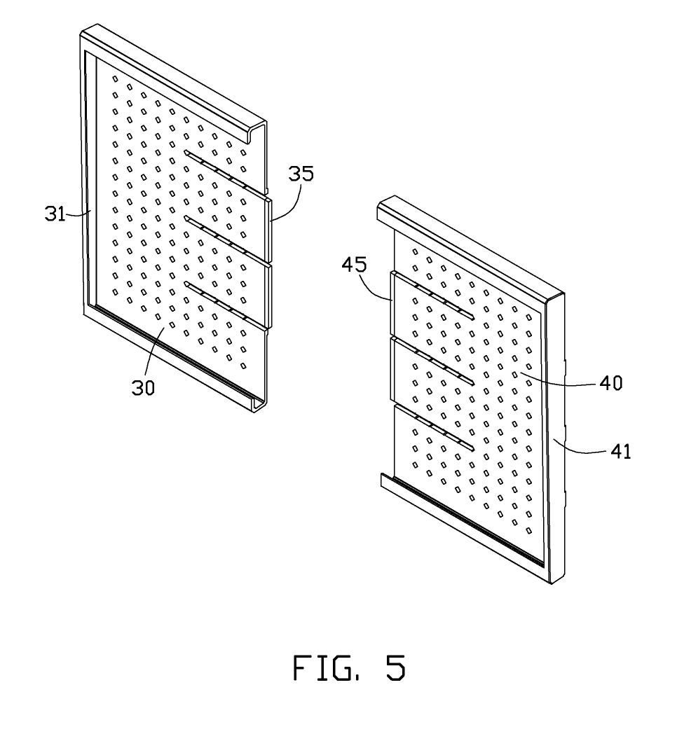

FIG. 5 illustrates a support assembly in a second embodiment. The support assembly includes a third supporting board 30 and a fourth supporting board 40. Two first snapping portions 35 are located on an inner lateral edge of the third supporting board 30. A first stop flange 31 is located on an outer lateral edge of the third supporting board 30. Two second snapping portions 45 are located on an inner lateral edge of the fourth supporting board 40. A second stop flange 41 is located on an outer lateral edge of the fourth supporting board 40. In the retaining state, the third supporting board 30 and the fourth supporting board 40 can be snapped to each other by the first snapping portions 35 and the second snapping portions 45. The first stop flange 31 and the second stop flange 41 can restrict the flat electronic device 100 from moving laterally in the retaining state. The first snapping portions 35 and the second snapping portions 45 can be magnet tabs.

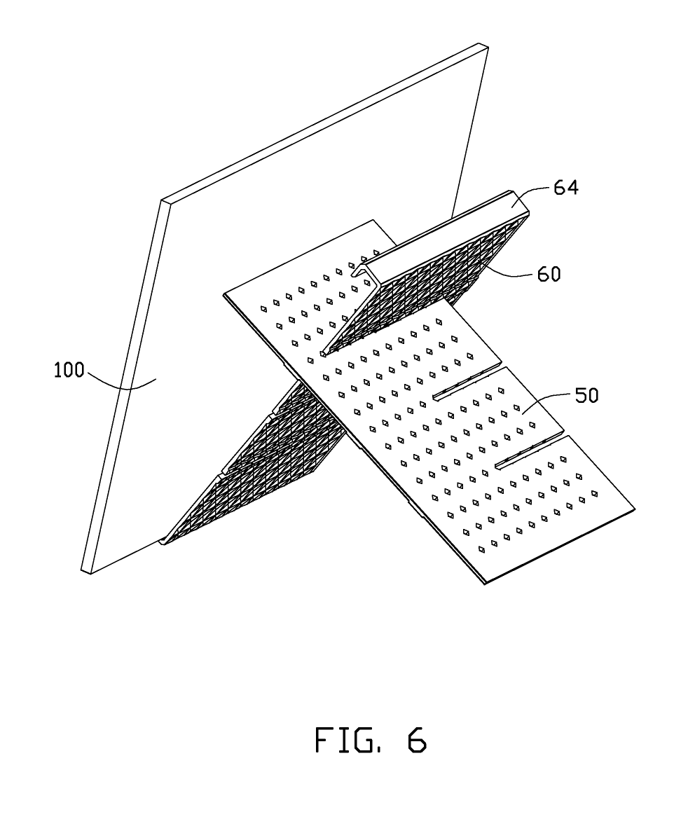

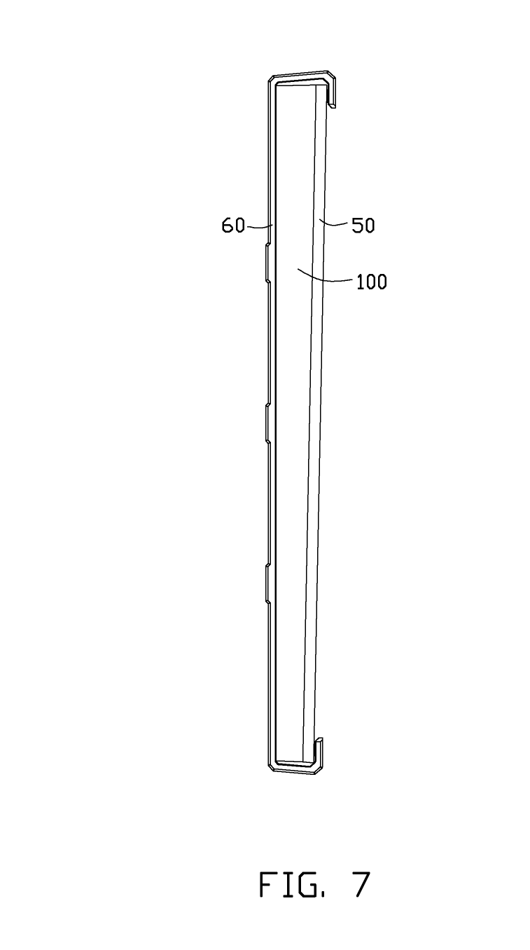

FIG. 6 and FIG. 7 illustrate a support assembly in a third embodiment. The support assembly includes a fifth supporting board 50 and a sixth supporting board 60. The sixth supporting board 60 may have the same configuration as the second supporting board 20. The fifth supporting board 50 may be a flat board without retaining portions. In the support state, the fifth supporting board 50 can support the back side of the flat electronic device 100. In the retaining state, the fifth supporting board 50 and the sixth supporting board 60 are retained on opposite sides of the flat electronic device 100 to totally cover the flat electronic device 100.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A support assembly for an electronic device comprising:
a first supporting board;
a second supporting board;
wherein at least one of the first supporting board and the second supporting board comprises a groove; at least one of the first supporting board and the second supporting board comprises a retaining portion for retaining the electronic device; the first supporting board and the second supporting board are configured to support the electronic device in a support state and retain the electronic device in a retaining state; in the support state, the first supporting board and the second supporting board intersect with each other and are engaged to each other through the groove; in the retaining state, the first supporting board and the second supporting board cover the electronic device and are retained to the electronic device through the retaining portion.

2. The support assembly of claim 1, wherein at least one first groove is defined in the first supporting board, at least one second groove is defined in the second supporting board, the first supporting board and the second supporting board are engaged to each other through one of the at least one first groove and one of the at least one second groove in the support state.

3. The support assembly of claim 2, wherein a first width of the first supporting board along an extending direction of the one of the at least one first groove is substantially equal to a second width of the one of the second supporting board along an extending direction of one of the at least one second groove, and the first width is substantially equal to a sum width of the one of the at least one of first groove and the one of the at least one second groove.

4. The support assembly of claim 2, wherein the at least one of first groove comprises a plurality of first grooves, the plurality of first grooves is substantially parallel to each other; the at least one of second groove comprises a plurality of second grooves, and the plurality of second grooves is substantially parallel to each other.

5. The support assembly of claim 1, wherein the retaining portion is resilient, and a cross section of each of the retaining portion is substantially L-shaped.

6. The support assembly of claim 1, wherein the first supporting board and the second supporting board substantially have same configuration.

7. The support assembly of claim 1, wherein the retaining portion is configured to retain the electronic device in the retaining state and clasp the electronic device in the support state.

8. The support assembly of claim 1, wherein the first supporting board and the second supporting board are aligned to each other in the retaining state, and at least one of the first supporting board and the second supporting board comprises a snapping portion that snaps the first supporting board to the second supporting board in the retaining state.

9. The support assembly of claim 1, wherein at least one of the first supporting board and the second supporting board comprises a stop flange, and an extending direction of the stop flange is substantially perpendicular to the groove.

10. The support assembly of claim 1, wherein the first supporting board and the second supporting board partially cover the electronic device in the retaining state.

11. A support assembly for an electronic device comprising:
a first supporting board, comprising at least one first retaining portion, at least one first groove defined in the first supporting board;
a second supporting board, comprising at least one second retaining portion;
wherein the first supporting board and the second supporting board are configured to support the electronic device in a support state and retain the electronic device in a retaining state; in the support state, the first supporting board and the second supporting board intersect with each other and the second supporting board is engaged in one of the at least one first groove; in the retaining state, the first supporting board and the second supporting board covers the electronic device and are retained to the electronic device through the at least one first retaining portion and the at least one second retaining portion.

12. The support assembly of claim 11, wherein at least one second groove is defined in the second supporting board, and one of the at least one first groove is configured to engage with one of the at least one second groove in the support state.

13. The support assembly of claim 12, wherein a first width of the first supporting board along an extending direction of the one of the at least one first groove is substantially equal to a second width of the one of the second supporting board along an extending direction of one of the at least one second groove, and the first width is substantially equal to a sum length of the one of the at least one of first groove and the one of the at least one second groove.

14. The support assembly of claim 12, wherein the at least one of first groove comprises a plurality of first grooves, the plurality of first grooves is substantially parallel to each other; the at least one of the second groove comprises a plurality of second grooves, the plurality of second grooves is substantially parallel to each other; the first supporting board and the second supporting board are configured to support the electronic device at a first angle when a first one of the plurality of first grooves is engaged with a first one of the plurality of second grooves, and the first supporting board and the second supporting board are configured to support the electronic device at a second angle when a second one of the plurality of first grooves is engaged with a second one of the plurality of second grooves.

15. The support assembly of claim 11, wherein the at least one first retaining portion and the at least one second retaining portion are resilient, and a cross section of each of the at least one first retaining portion and the at least one second retaining portion is substantially L-shaped.

16. The support assembly of claim 11, wherein the first supporting board and the second supporting board substantially have same configuration.

17. The support assembly of claim 11, wherein one of the at least one first retaining portion and the at least one second retaining portion is configured to retain the electronic device in the retaining state and clasp the electronic device in the support state.

18. The support assembly of claim 11, wherein the first supporting board and the second supporting board are aligned to each other in the retaining state, and at least one of the first supporting board and the second supporting board comprises a snapping portion to snap the first supporting board to the second supporting board in the retaining state.

19. The support assembly of claim 11, wherein at least one of the first supporting board and the second supporting board comprises a stop flange, and an extending direction of the stop flange is substantially perpendicular to the one of the at least one first groove.

20. The support assembly of claim 11, wherein the first supporting board and the second supporting board partially cover the electronic device in the retaining state.
